(19) United States
(12) Patent Application Publication
(10) Pub. No.: US 2015/0331998 A1
(43) Pub. Date: Nov. 19, 2015

(54) MEDICAL INFORMATION ACCESS PORTAL

(71) Applicant: eData Platform, Corp., Fort-Lauderdale, FL (US)

(72) Inventors: Nathan Rozenfeld, Davie, FL (US); Vladimir Bogin, Longview, WA (US)

(21) Appl. No.: 14/715,408

(22) Filed: May 18, 2015

Related U.S. Application Data
(60) Provisional application No. 62/000,037, filed on May 19, 2014.

(51) Int. Cl. G06F 19/00

(52) U.S. Cl. CPC G06F 19/322

(57) ABSTRACT

Methods and apparatus, including computer program products, for a medical information access portal. A system includes a provider server including an electronic medical record (EMR) database, a hospital server including a hospital information system database, and a host server including a medical information access portal, the medical information access portal configured to exchange patient data between the EMR database of the provider server and the hospital information system database of the hospital server.

### CROSS REFERENCE TO RELATED APPLICATIONS

This application claims priority to U.S. Provisional Application No. 62/000,037, filed May 19, 2014, the entire contents of which is hereby incorporated by reference.

### BACKGROUND OF THE INVENTION

The present invention generally relates to healthcare systems, and more specifically to a medical information access portal.

As is generally known, an average Medicare patient sees seven physicians, five specialists, in four different practices. A typical primary care physician annually coordinates care with 229 physicians in 119 practices. Ineffective care coordination leads to inefficient care and duplication of diagnostic tests results in over-treatment at an annual cost that is estimated at $148-226 Billion.

Currently, all patient information is contained either within traditional paper charts or in siloed electronic medical records (EMRs) and Health Information Systems (HIS). The vast majority of patients receive diagnostic services and medical care from many different providers who utilize different HIS/EMR systems and the lack of a solution for providing immediate access to “out-of-network” patient-related medical records is a tremendous unmet medical need.

Medical records technicians and other office staff are continually accessing the paper charts or local EMR systems, as information becomes available, making a patient chart a central element in many different pre- and post-visit tasks. However, quick turnaround deliverables of information exchange with external facilities cannot be accomplished due to antiquated methods that are currently being used. In most cases it takes days or weeks and intensive manual labor to achieve the goal of populating patients' medical records with up-to-date information.

In many scenarios, an inability of healthcare providers to access relevant records at the point of care results in ordering of unnecessary and repetitious tests and procedures. This common pattern leads to an added burden of extra expenses that in many cases can be easily avoided if there existed a portal that could retrieve the requested information in a real time mode. The lack of timely access to external records can also lead to harming patients by erroneous treatments and by exposing them to unjustified tests and procedures.

Diligent assessment of available solutions on the market shows lack of an existing off-the-shelf solution that can act as an interface between multiple EMR systems. Adapting existing inadequate software systems is costly in the short term, requires providers to adopt new and not always suitable systems or be hampered by restrictive workflows in the application that are not customizable for such tasks.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention provides methods and apparatus, including computer program products, for a medical information access portal.

In general, in one aspect, the invention features a system including a medical information access portal configured to exchange patient data between requesting providers and participating hospitals, the medical information access portal enabling customized workflows to enhance presentation for users, the workflows providing a view of a single encounter linked to recent sources on a patient's symptoms or conditions and a complete history of the patient's healthcare utilization.

In another aspect, the invention features a system including a provider server including an electronic medical record (EMR) database, a hospital server including a hospital information system database, and a host server including a medical information access portal, the medical information access portal configured to exchange patient data between the EMR database of the provider server and the hospital information system database of the hospital server.

In another aspect, the invention features a method including providing a provider server including an electronic medical record (EMR) database, providing a hospital server including a hospital information system database, and providing a host server including a medical information access portal, the medical information access portal configured to exchange patient data between the EMR database of the provider server and the hospital information system database of the hospital server.

Embodiments of the invention may have one or more of the following advantages.

The present invention is an easy to use system that enables secure data sharing between the health information access portal and multiple EMRs with clearly defined patient content presentation.

The present invention provides a level of care validation and does not require additional administrative staff.

The present invention enables streamlining and reduction of existing administrative processes, requires a minimum of keystrokes to execute tasks, and can be tailored to any specialty-specific workflows.

The present invention provides secure access for healthcare providers, an ability to consent patients for immediate release of medical information with various degrees of clearance, and easy integration with existing HIS and EMR solutions.

The present invention streamlines federated information search and delivery, enables real time provider's access to a complete patient dataset, allows various levels of decision making rules and approaches.

The present invention improves productivity, an ability to seamlessly interface with all existing practice management systems, eliminates or reduces the number of internal auditing processes, and allows secure data exchange with affiliated hospitals and practices.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

The invention will be more fully understood by reference to the detailed description, in conjunction with the following figures, wherein:

FIG. 1 is a block diagram of overall deployment and data flow of the a medical information access portal.

FIG. 2 is a block diagram of access authentication and information retrieval of the medical information access portal.

FIG. 3 is a block diagram of practical scenarios of the medical information access portal.

FIG. 4 is a block diagram of registered patient/provider data access flow of the medical information access portal.

FIG. 5 is a block diagram of an external (not yet registered) patient/provider data access flow of the medical information access portal.

FIG. 6 is a block diagram of patient visit workflow of the medical information access portal.

FIG. 7 is a block diagram of processing request for information workflow of the medical information access portal.

FIG. 8 is a block diagram of handling content within the requesting agency workflow.

FIG. 9 is a block diagram of an incoming/outgoing medical messaging processing workflow.

FIG. 10 is a block diagram of a healthcare patient/registered provider workflow.

FIG. 11 is a block diagram of a healthcare patient/external provider workflow.

FIG. 12 is a table of exemplary functional specifications.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “system,” “platform,” and the like can refer to a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

In addition, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

In the following detailed description, references are made to the accompanying drawings that form a part hereof, and in which are shown by way of illustration specific embodiments or examples.

The medical information access portal of the present invention is a cloud-based application with workflows that can be configured to support multiple processes and tasks. The technology core of this portal is patient-centric and supports a continuum of end-to-end care, enabling the capture and access of patient data from routine doctor visits and laboratory work to out-of-network consultations, emergency room (ER) visits, hospitalizations, prescription drug use and participation in clinical trials. One cardinal feature of the medical information access portal of the present invention is that it does not store patient data within the platform, but rather acts as an exchange interface between the requesting providers and participating HIS/EMR systems. This doesn't negate a provider's ability to retrieve and to store locally all the necessary data using various platforms (e.g. desktops, mobile, tablets, and so forth), as well as from systems already in place. The medical information access portal is a role-based solution, enabling customized views that enhance presentation for users. With the medical information access portal, a workflow can include a view of a single encounter linked to the most relevant and recent sources on the patient's symptoms or conditions. Workflows are able to provide complete history of patient's healthcare utilization. Data analytics and dashboard views assist a provider with diagnoses and minimizing the need for extra keystrokes and clicks. The medical information access portal integrates online resources and document management and also enables user-defined dashboard elements for easy monitoring and tracking of critical changes with built-in alerts for regular healthcare providers.

Core features of the medical information access portal include of or more the following.
A repository of registered and participating facilities and providers.
Providers' profiles and their information interoperability profile (content that can be extracted and shared with registered and authorized users).
Bi-directional interoperability solution with existing HIS/EMR solutions to enable secure, quick and meaningful information query and return.
Easy to use and operate patient content portal available to all registered providers.
Patient profile describing key elements of patient current state of health and critical decisions.
Proprietary point of care identification and validation system that enables secure access of the portal and to participating HIS/EMR solutions.

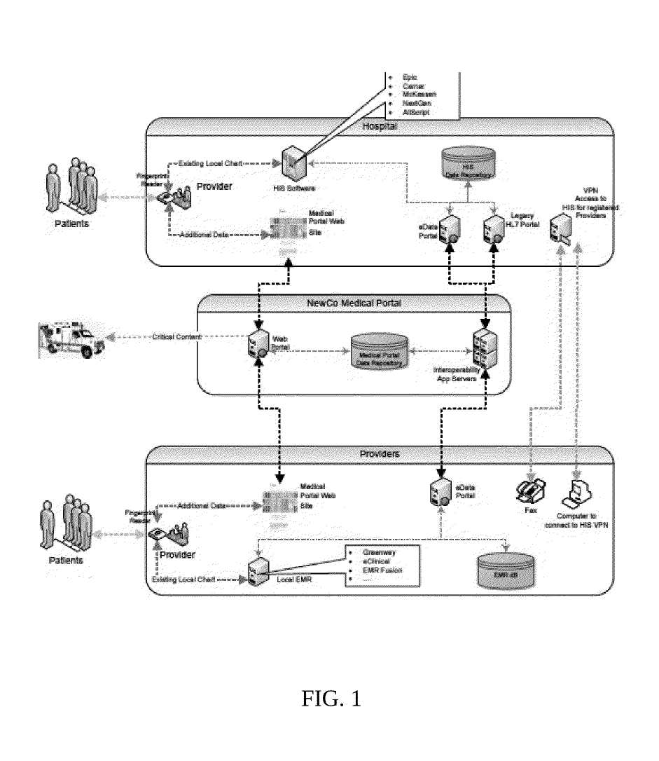

FIG. 1 is a block diagram of overall deployment and data flow of the medical information access portal.

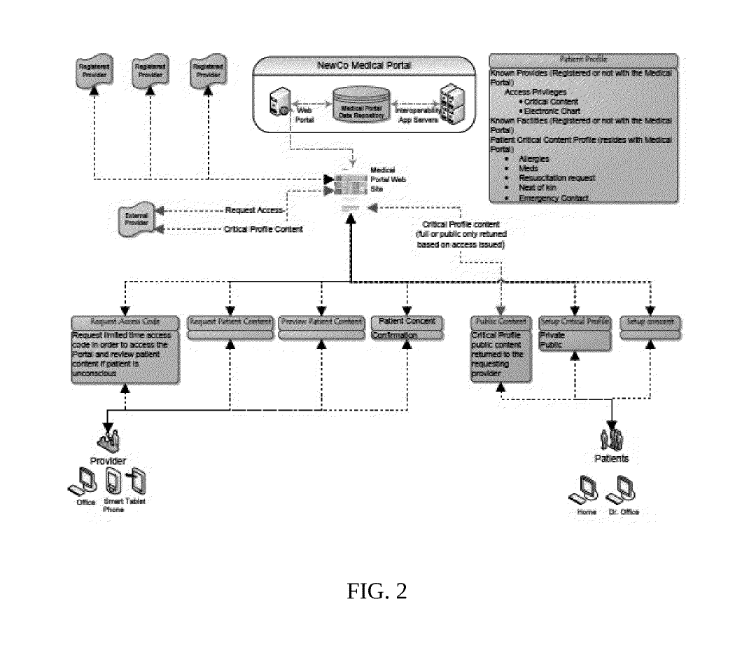

FIG. 2 is a block diagram of access authentication and information retrieval of the medical information access portal.

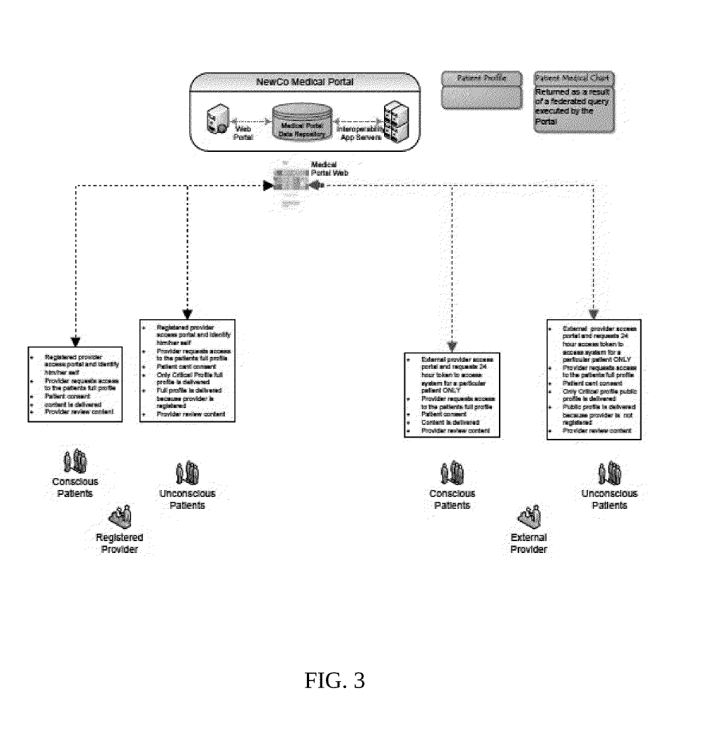

FIG. 3 is a block diagram of practical scenarios of the medical information access portal.

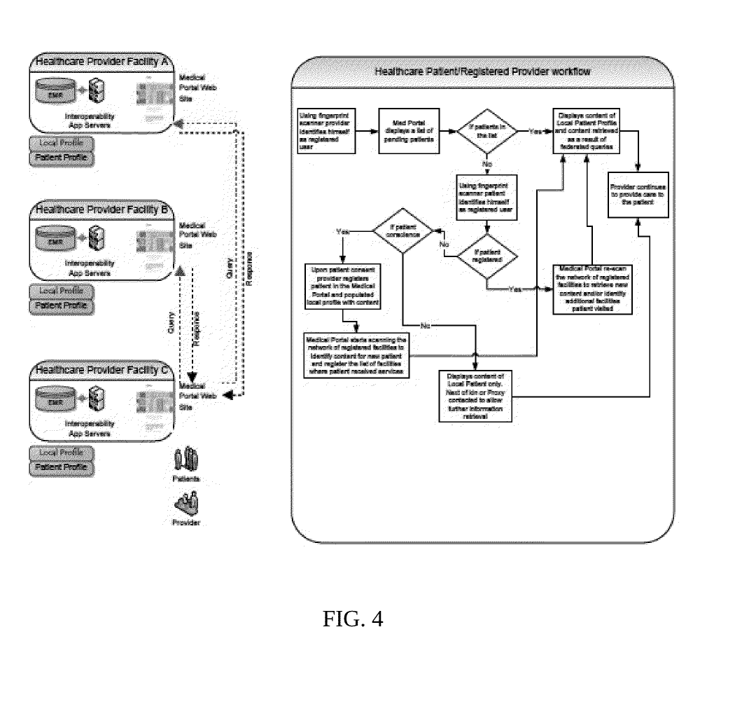

FIG. 4 is a block diagram of registered patient/provider data access flow of the medical information access portal.

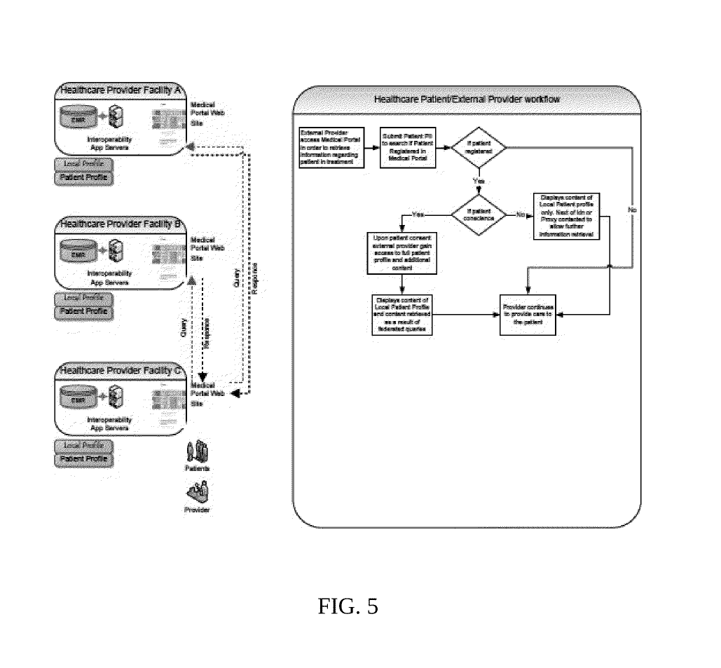

FIG. 5 is a block diagram of an external (not yet registered) patient/provider data access flow of the medical information access portal.

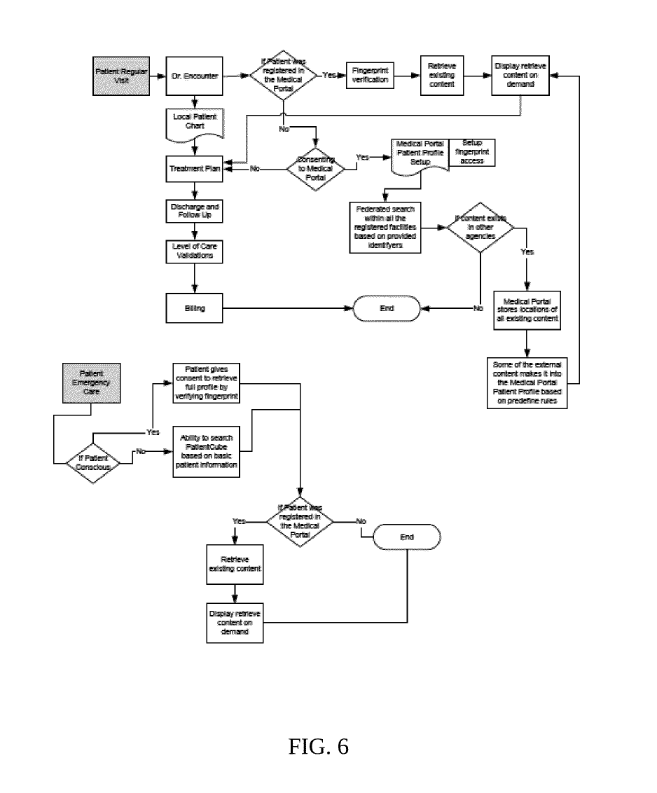

FIG. 6 is a block diagram of patient visit workflow of the medical information access portal.

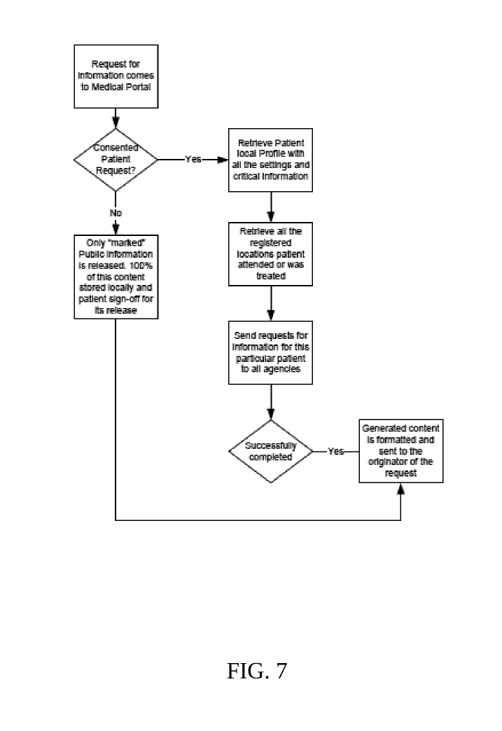

FIG. 7 is a block diagram of processing request for information workflow of the medical information access portal.

The medical information access portal includes one or more of the following work-flow concepts.

Fingerprint Identification and Access

The medical information access portal includes a patient-centric system of access to medical records across all healthcare networks and all software systems that will be immediately available to accredited healthcare providers at the point of care.

The patient-centric system of access uses a patient's fingerprints as a unique access key into secure, CFR part 11 compliant, web-based software system. The fingerprints are captured through a designated device which offers the most advanced level of cyber-security. The system has access to medical records of all participating institutions. In implementations, fingerprint scanning is done through either a handheld device with wireless internet connection that has either built-in or USB-enabled fingerprinting capabilities or through a fingerprint scanning port connected to a stationary computer.

1. New Patient Registration

The two most likely locations for patient enrollment include outpatient and inpatient medical facilities. In an outpatient setting, a patient who is new to the patient-centric system of access is asked if he/she wants to join the medical information access portal. A brochure that explains the benefits is given and if the patient agrees to sign up, the office receptionist/medical assistant collects all basic information on the patient. Date of birth (DOB) and a full name are used for identification and data quarries. The patient is then asked to scan his/her fingerprint and it is synchronized with the collected metric data. A handheld device with a scanner or a stationary computer with an attached scanner can be used.

2. Data Extraction and its Meaningful Use by an Outpatient Provider

The data crawlers match the newly registered patient with all participating medical facilities. The list of facilities where the patient had previously received care is retained by the software and is automatically updated at the time of each visit.

After the registration process is completed, the receptionist/assistant “pairs” the patient with the medical provider that the patient is scheduled to see and an automatic access link is sent to the provider through patient-centric system of access' software system. Advanced “pairing” is available for the returning patients and can take place when daily schedule is finalized.

The provider opens the patient-centric system of access using his/her own fingerprint if a handheld device is used or via an ID/Password when a stationary computer is used.

The patient is listed in the queue and the provider can review the records at any point before, during or after the visit.

When the patient returns for a follow up visit and is again “paired” with the provider, the provider can immediately see if the patient has received any health care since the last visit. These visits can be “flagged” by the system based on provider's preferences. The provider can also review all the laboratory tests that had been performed at participating laboratories, all prescriptions that had been filled out in participating pharmacies, all the imaging studies that had been performed at participating imaging centers.

In addition, participating providers can alert each other to critical information. For instance, a laboratory technician can flag a test result for the ordering provider to review and it will show up in provider's queue. An inpatient provider can notify the outpatient provider of patient's dismissal from the hospital and flag this provider to review the discharge summary. A consultant can flag a referring physician when the consultation note is transcribed.

Conversely, the provider can set up alerts that inform him/her of when the patient is seen by the consultant, when a new laboratory test is posted in the lab system, and so forth.

3. Security and Access Clearance:

At the time of registration or at any ensuing encounter with the provider, the patient may opt for one of several levels of access clearance and change such clearance at will:

Basic information: age, major medical history, allergies, blood type, emergency contact information, but without possibility of accessing external healthcare records.

Limited access: the above info, plus ability to access data from other facilities/providers only in case of a life-threatening emergency or after an okay from health care proxy on file.

Complete access to all records from every participating facility is at health care provider's discretion.

Different health care providers have different “clearance levels” as well. For instance, Emergency Medical Service (EMS) personnel are able to see the most critical information, pharmacy staff will be granted specific information on prior prescription pattern at other participating pharmacies, and an ER physician or a subspecialty consultant is granted full access.

4. Non Participating Providers

Non-participating providers may also be able to enter the system. The patient may give the external provider access to records by disclosing his/her login name and password. When the provider logs in, he/she can enter his/her information and send a request to the patient-centric system of access support department in order to receive temporary clearance to viewing the patient's data. The support team then verifies the identity of the provider and temporary access is then granted.

5. Patient Portal

Each participating patient has an active role in his/her care by utilizing a patient-centric system of access patient portal. The patient is able to alert the primary care provider or a sub-specialist of changes in the state of health, new hospital or ER visits, newly prescribed medications, and so forth.

These data are entered as “patient's notes” and available to a provider for review at the time of routine visit. It is made abundantly clear through disclaimers that none of the entered information can be of urgent nature.

Primary care physicians are also able to enter information into a patient portal and this information can be distributed to an individual patient, to all patients, or to the subgroup of patients based on specific characteristics (age, gender, health status).

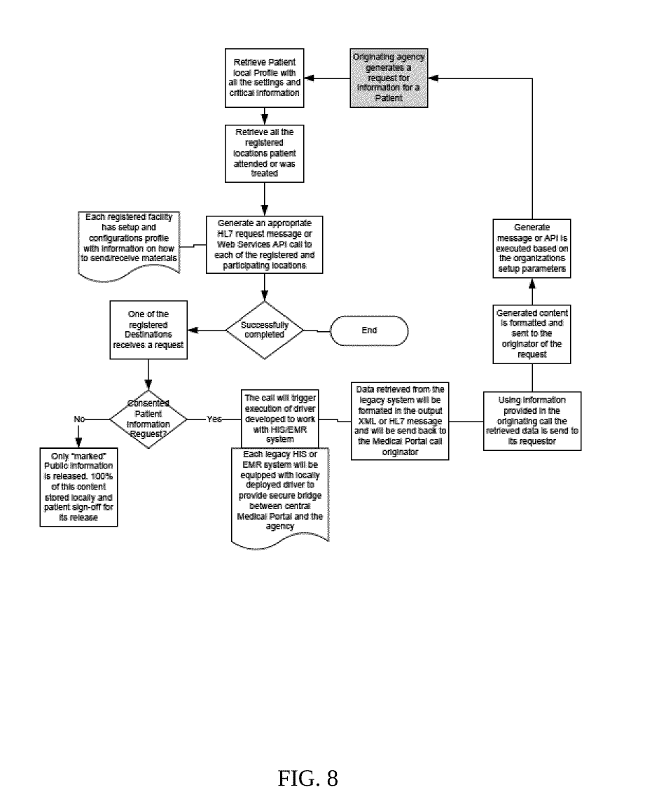

FIG. 8 is a block diagram of handling content within the requesting agency workflow.

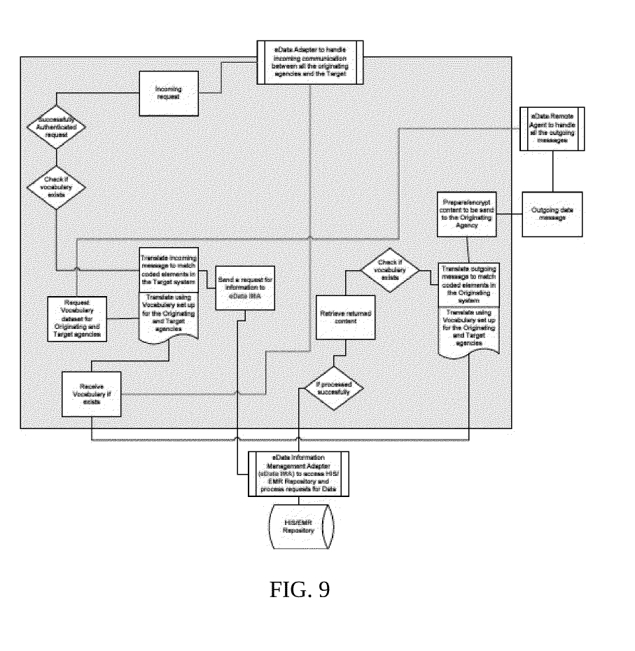

FIG. 9 is a block diagram of an incoming/outgoing medical messaging processing workflow.

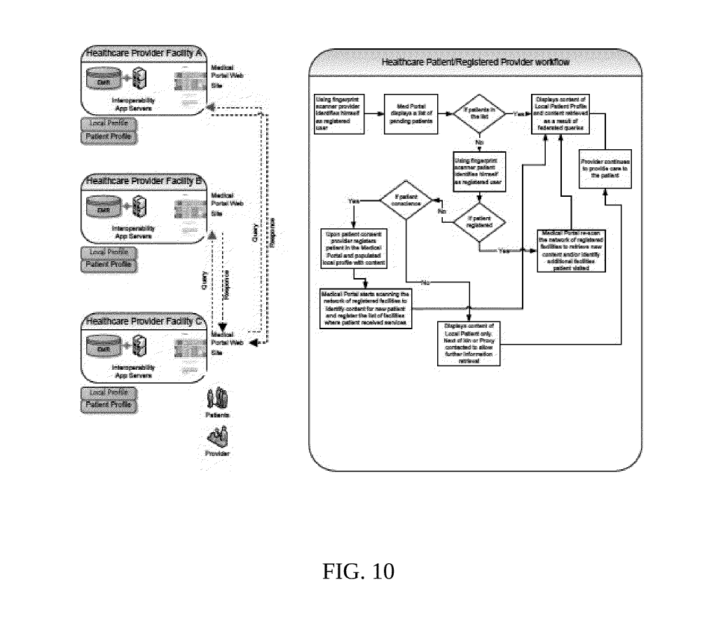

FIG. 10 is a block diagram of a healthcare patient/registered provider workflow.

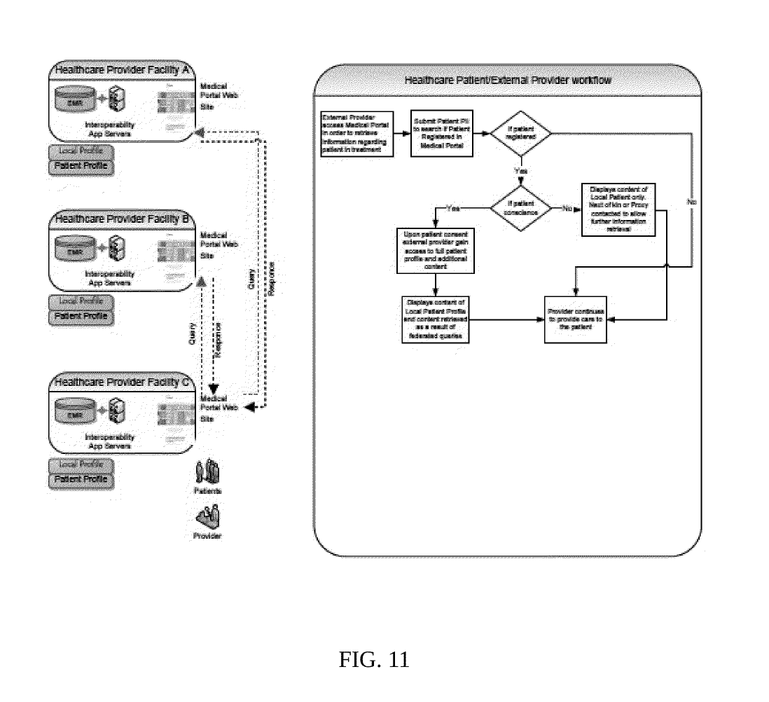

FIG. 11 is a block diagram of a healthcare patient/external provider workflow.

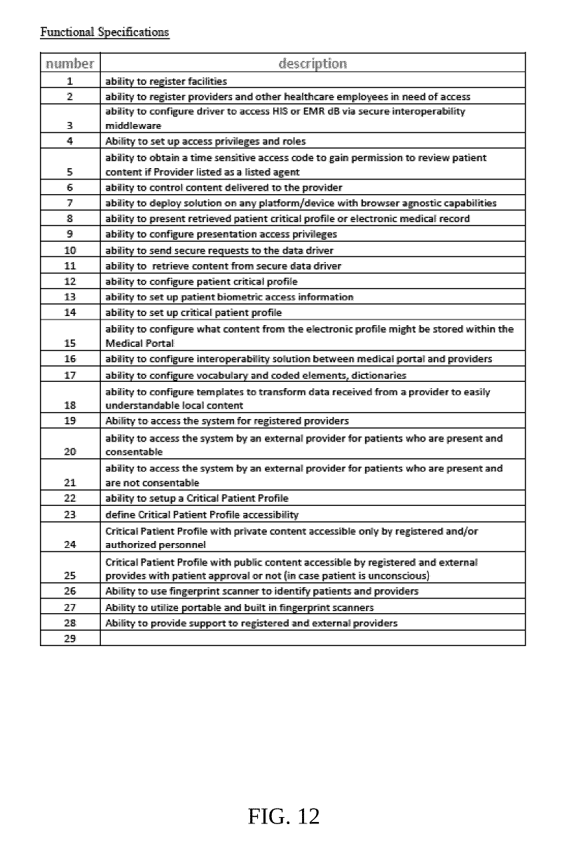

FIG. 12 is a table of exemplary functional specifications.

To better understand the present invention, the following exemplary cases are presented. In each case, two scenarios are illustrated, i.e., a scenario A in each case represents a current state of medical care and a scenario B represents an implementation of the medical information access portal of the present invention.

Case 1

A patient is a young female who is brought to the hospital's ER by local police after being found wondering around and screaming obscenities at passers-by. The patient is restless, paranoid and is unable to provide any meaningful information. She is without any identifying documents.

Case 1, Scenario A:

As the patient has never been seen locally and no information on the patient is available, the ER physician begins a comprehensive work up, ordering a drug screen and routine blood tests. The tests are unremarkable and a computer tomogram of the head and then a lumbar puncture are performed. Both tests are within normal limits. A psychiatrist is then called and makes a presumptive diagnosis of bipolar disorder with psychosis and prescribes an antipsychotic medication that is administered intravenously. Twenty minutes later the patient develops a severe allergic reaction which requires emergent intubation, placement of the patient on a ventilator and transfer to the intensive care unit. Twenty-four hours later an acquaintance of the patient comes to the hospital and provides the medical team with some basic information and contact details of patient's parents. It turns out that the patient suffers from a long-standing psychiatric illness and has been missing for several weeks. She has a known allergy to the antipsychotic medication that was given to her in the ER.

Case 1, Scenario B:

An ER physician securely accesses the medical information access portal, which shows that the patient is “in the system”, but indicates that any additional information can only be retrieved with the permission of patient's health care proxy (HCP) whose name and contact information are listed. Before the ER physician can call the HCP, he receives a call from the operator that indicates that the HCP is asking to speak with him. The software system already alerted the HCP via a text message and an email, which identified the facility and the identity of the physician who attempted to retrieve patient's information.

It turns out that the patient suffers from a long-standing psychiatric illness and has been missing for several weeks. After speaking to the HCP, the ER physician is able to enter the medical information access portal and retrieve all pertinent medical and prescription information (including patient's allergies), from several institutions and treating physicians. As presenting symptoms mirror prior visits, the ER physician decides against performing both the imaging studies and the lumbar puncture. The antipsychotic medication that worked well on previous occasions is given and the patient's condition quickly improves.

Conclusion

Immediate access to data has allowed to save significant health care resources, avoid risky and unnecessary medical tests and procedures and prevent direct harm to the patient.

Case 2

A patient comes to establish with a new primary care physician. He has been living in several states over the past ten years and has been receiving sporadic medical care at emergency departments of different hospitals and has been hospitalized twice for a major abdominal surgery and for a cardiac device implantation. Patient recently moved to this area and has very limited knowledge of his medical history. In the past he has been prescribed several unspecified medications for “blood pressure and cholesterol” but ran out of them 6 months ago. He cannot recall the names of any of the facilities that he has been treated at.

Case 2, Scenario A

The physician tries to collect as much information as possible during the initial visit, but is unable to establish the chronology or the origin of most of patient's health problems. She asks the patient to sign several release forms and tasks her medical record tech to FAX them to several hospitals and urgent care centers in the cities where the patient presumably received his medical care. As the patient's blood pressure is elevated, she prescribes two blood pressure medications and asks the patient to return a week later. At the second visit no requested records have been received, but the patient recalls the name of one of the hospitals. Another release form is obtained and faxed to that institution. Patient complains of having developed a cough and a chest X-ray is performed and is negative. It is decided that the cough is a side effect of one of the medications and it is stopped. As chances of getting external medical records appear to be low, the patient is scheduled to have an ECG and a complete panel of blood tests. The tests show some kidney dysfunction and an ultrasound is ordered. After patient's ECG comes back abnormal, he is referred to see a cardiologist and a stress echocardiogram is ordered and performed.

Two weeks later the records from one of the external hospitals come in and it turns out that the patient just underwent a very thorough work up eight months ago and that all the performed tests have already been done.

Case 2, Scenario B

The medical information access portal Health confirms patient's enrollment during one of his previous hospitalizations. The primary care physician is immediately able to access all medical records from participating institutions and obtain crucial information on patient's medical and surgical history, prior medication use, allergies, and so forth. She is able to highlight the most pertinent parts of the records and “cut and paste” them into his EMR system immediately. Appropriate blood pressure medications that have worked in the past are prescribed.

Conclusion:

Utilization of the medical information access portal has lead to significant health care savings, avoided a medication-induced allergic reaction and reduced office overhead

Case 3

An elderly gentleman passes out while shopping at the supermarket. He is unresponsive and without a pulse; bystanders try to perform a CPR and 911 is called. Emergency medical personnel arrives and take over the resuscitation efforts.

Case 3, Scenario A

While CPR is ongoing, the EMTs find patient's ID in his wallet, but no contact information is available and it is presumed that patient is a “Full Code”, thus CPR is continued, patient is intubated and transported to the hospital where an ER rapid response team takes over, the CPR continues, multiple medications are used, electric shocks are administered. The pulse is restored and the patient is placed on a ventilator and several intravenous medications are started in order to sustain adequate blood pressure. The ER care coordinator eventually locates patient's family and is told that the patient has advanced prostate cancer and has filled out a “Do Not Resuscitate” form as part of his advanced directives. The ER physician is reluctant to discontinue the life support and does so only when the family arrives with the copy of the form.

Case 3, Scenario B

Immediate query if the medical information access portal shows patient's advanced directives that clearly indicate a “Do Not Resuscitate” status. Patient's family is called, CPR is stopped and patient expires peacefully. Patient's body is taken to the funeral home.

Conclusion

Patient's wishes are honored, family is immediately notified and significant unjustified health care expenses are avoided.

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system comprising:
in a network of interconnected computers, a medical information access portal configured to exchange patient data between requesting providers and participating hospitals, the medical information access portal enabling customized workflows to enhance presentation for users, the workflows providing a view of a single encounter linked to recent sources on a patient's symptoms or conditions and a complete history of the patient's healthcare utilization.

2. The system of claim 1 wherein the medical information access portal comprises a repository of registered and participating facilities and providers.

3. The system of claim 2 wherein the medical information access portal further comprises providers' profiles and their corresponding interoperability profiles.

4. The system of claim 1 wherein the medical information access portal comprises a validation system.

5. The system of claim 4 wherein the validation system comprises a patient fingerprint reader.

6. The system of claim 4 wherein the validation system comprises a patient biometric reader.

7. The system of claim 1 wherein each of the requesting providers comprises a network storing an electronic medical record (EMR) database.

8. The system of claim 1 wherein each of the participating hospitals comprises a network storing a hospital information system database.

9. The system of claim 1 wherein the medical information access portal comprises data analytics and dashboard views to assist each of the requesting parties and each of the participating hospitals with patient diagnoses.

10. The system of claim 1 wherein the medical information access portal comprises integrated online resources and document management.

11. The system of claim 1 wherein the medical information access portal comprises user-defined dashboard elements for monitoring and tracking critical changes with built-in alerts for each of the requesting providers.

12. A system comprising:
in a network of interconnected computers, a provider server comprising an electronic medical record (EMR) database;
a hospital server comprising a hospital information system database; and
a host server comprising a medical information access portal, the medical information access portal configured to exchange patient data between the EMR database of the provider server and the hospital information system database of the hospital server.

13. The system of claim 12 wherein the medical information access portal is configured to enable customized workflows to enhance presentation for users, the workflows providing a view of a single encounter linked to recent sources on a patient's symptoms or conditions and a complete history of the patient's healthcare utilization.

14. The system of claim 13 wherein the medical information access portal further comprises a validation system, the validation system including one of a patient fingerprint reader or a patient biometric reader.

15. The system of claim 14 wherein the medical information access portal further comprises user-defined dashboard elements for monitoring and tracking critical changes with built-in alerts for the provider server.

16. A method comprising:
in a network of interconnected computers, providing a provider server comprising an electronic medical record (EMR) database;
providing a hospital server comprising a hospital information system database; and
providing a host server comprising a medical information access portal, the medical information access portal configured to exchange patient data between the EMR database of the provider server and the hospital information system database of the hospital server.

17. The method of claim 16 wherein the medical information access portal is configured to enable customized workflows to enhance presentation for users, the workflows providing a view of a single encounter linked to recent sources on a patient's symptoms or conditions and a complete history of the patient's healthcare utilization.

18. The method of claim 17 wherein the medical information access portal further comprises a validation system, the validation system including one of a patient fingerprint reader or a patient biometric reader.

19. The method of claim 18 wherein the medical information access portal further comprises user-defined dashboard elements for monitoring and tracking critical changes with built-in alerts for the provider server.
